(19) United States
(12) Patent Application Publication
(10) Pub. No.: US 2012/0168380 A1
(43) Pub. Date: Jul. 5, 2012

(54) ZEOLYTIC SULFUR GUARD

(75) Inventor: Georges N. Z. Mendakis, League City, TX (US)

(73) Assignee: CLS INDUSTRIAL PURIFICATION, LLC, Clear Lake Shores, TX (US)

(21) Appl. No.: 13/395,237

(22) PCT Filed: Sep. 9, 2010
(86) PCT No.: PCT/US10/48301

§ 371 Date: Mar. 9, 2012

(30) Foreign Application Priority Data
Sep. 9, 2009 (US) 61240954

(51) Int. Cl. B01D 15/00; B32B 1/08; B01D 53/02; B32B 3/00; C09K 3/00; B01D 53/52

(52) U.S. Cl. 210/660; 252/190; 423/231; 95/136; 428/219; 428/34.1

(57) ABSTRACT

A composition useful for the adsorptive removal of hydrogen sulfide from a gas or liquid stream, the composition comprising ferric oxide and a zeolyte group. The zeolyte group may comprise aluminum and silicon at a ratio in the range from about 1 part aluminum to 100 parts silicon to about 100 parts aluminum to 1 part silicon, and have a mix of amorphous aluminosilicate and structured zeolyte, wherein the structured zeolyte comprises a distribution of zeolytic cells ranging in size from about 3 Angstroms to about 16 Angstroms. Also disclosed is a process for removing hydrogen sulfide from various process stream by contact with such a composition.

### BACKGROUND OF DISCLOSURE

1. Field of the Disclosure

Embodiments disclosed herein relate generally to the removal of hydrogen sulfide from hydrogen, carbon dioxide, natural gas, and hydrocarbon vapor or liquid streams. More specifically, embodiments disclosed herein relate to the use of an iron-based zeolytic material to adsorb hydrogen sulfide.

2. Background

Hydrogen sulfide is a highly toxic and corrosive environmental pollutant with an obnoxious smell that needs to be removed from various streams for pollution control, corrosion protection, as well as process requirements in various industries. Natural gas processing complexes, refineries, sulfur processing chemicals industries, pharmaceutical industries, sugar industries, sewage treatment plants, carbon dioxide purification systems, and bio-gas generating units are some of the major industries requiring removal of hydrogen sulfide from various process streams.

A number of processes have been known and are in commercial use for removing hydrogen sulfide from gas streams, including the Claus process and the Liquid Redox process. The Claus process is used for removing hydrogen sulfide from gases containing typically high concentration of H₂S (more than 20% by volume H₂S). The Liquid Redox process is used for removing hydrogen sulfide from gases containing typically low concentration of H₂S.

Processes using iron sponges (iron oxide deposited on wood shavings) as catalyst have also been in use for removing hydrogen sulfide from gases. The major disadvantage with iron sponges and similar materials is that they cannot be regenerated, are used as only once-through catalysts, and must be disposed as waste after use. Therefore, the cost of such treatment is high due to the use of stoichiometric quantities of chemicals and also disposal of the used materials. Further, the extent to which the wood shavings can be loaded (loading capacity) with iron oxide is low, thus limiting the hydrogen sulfide removal capacity.

In other processes for hydrogen sulfide removal, zinc oxide or a mixture of zinc oxide and copper oxide are used. Cost and the need for higher temperatures for effective removal are disadvantages for use of zinc and copper, as the gas needs to be preheated prior to treatment.

SULFATREAT, a mixed metal oxide adsorbent, available from SULFATREAT, St. Louis, Mo., and SULFUR GUARD, available from MicroPure Filtration Inc., Mound, Minn., are two systems currently being used for removal of hydrogen sulfide from various process streams. Removal of hydrogen sulfide from various gas streams is also disclosed in U.S. Pat. Nos. 7,556,671, 7,569,199, 7,481,985, 7,396,522, 6,040,259, and 4,831,206, among others.

The processes and catalysts used for the removal of hydrogen sulfide from various process streams have one or more disadvantages including once-through usage, high raw material costs, high disposal costs, and temperature limitations. In some cases, the compositions used become pyrophoric when contacted with hydrogen sulfide.

Accordingly, there exists a continuing need for alternative compositions that are useful for the removal of hydrogen sulfide from various process streams.

### SUMMARY OF THE DISCLOSURE

In one aspect, embodiments disclosed herein relate to a composition useful for the adsorptive removal of hydrogen sulfide from a gas or liquid stream, the composition comprising ferric oxide and a zeolyte group, the zeolyte group: comprising aluminum and silicon at a ratio in the range from about 1 part aluminum to 100 parts silicon to about 100 parts aluminum to 1 part silicon; and having a mix of amorphous aluminosilicate and structured zeolyte; wherein the structured zeolyte comprises a distribution of zeolytic cells ranging in size from about 3 Angstroms to about 16 Angstroms. In some embodiments, the zeolyte group may include clinoptilolite.

In another aspect, embodiments disclosed herein relate to a process for the adsorptive removal of hydrogen sulfide from a gas or liquid stream, the process comprising: contacting a gas, liquid, or gas/liquid mixture having a first concentration of hydrogen sulfide with a composition comprising ferric oxide and a zeolyte group to produce an effluent having a second concentration of hydrogen sulfide less than the first concentration of hydrogen sulfide. The zeolyte group may comprise aluminum and silicon at a ratio in the range from about 1 part aluminum to 100 parts silicon to about 100 parts aluminum to 1 part silicon; and have a mix of amorphous aluminosilicate and structured zeolyte; wherein the structured zeolyte comprises a distribution of zeolytic cells ranging in size from about 3 Angstroms to about 16 Angstroms. In some embodiments, the zeolyte group may include clinoptilolite.

Other aspects and advantages will be apparent from the following description and the appended claims.

### BRIEF DESCRIPTION OF DRAWINGS

FIG. 1 is a simplified process flow diagram of a process for removing hydrogen sulfide from a process stream according to embodiments disclosed herein.

FIG. 2 is a simplified process flow diagram of a process for removing hydrogen sulfide and other impurities from a process stream according to embodiments disclosed herein.

### DETAILED DESCRIPTION

In one aspect, embodiments disclosed herein relate to the removal of hydrogen sulfide from hydrogen, carbon dioxide, natural gas, and hydrocarbon vapor or liquid streams. More specifically, embodiments disclosed herein relate to the use of an iron-based zeolytic composition for the adsorptive removal of hydrogen sulfide from various process streams.

Embodiments disclosed herein may be used to reduce or remove hydrogen sulfide from gas, liquid, or mixed vapor/liquid streams containing hydrogen sulfide. Natural gas process or production streams, refinery petroleum streams, such as a cracker or reformer effluent or a partially or fully hydrotreated (including hydrodesulfurized) petroleum streams, hydrogen gas streams, such as a hydrogen gas effluent from a hydrogen sulfide stripper or an amine absorption unit, carbon dioxide gas streams, and numerous other streams may contain hydrogen sulfide. Prior to downstream processing or sale of a product stream, including pipeline sales streams, the hydrogen sulfide in these streams must be reduced or removed, such as to protect against corrosion, poisoning of catalysts, and/or to meet various governmental or industry imposed standards.

In some embodiments, the concentration of hydrogen sulfide in streams to be treated according to embodiments disclosed herein may be as high as 10000 ppm or greater. In other embodiments, the concentration of hydrogen sulfide in streams to be treated according to embodiments disclosed herein may be in the range from about 1 ppm to about 1000 ppm; in the range from about 5 ppm to about 500 ppm in other embodiments; and in the range from about 10 ppm to about 100 ppm in yet other embodiments.

The hydrogen sulfide may be removed from process streams by contacting the gas, liquid, or gas/liquid mixture containing hydrogen sulfide with a composition comprising ferric oxide and a zeolyte group. The zeolyte group may include aluminum and silicon at a weight ratio in the range from about 1 part aluminum to 100 parts silicon to about 100 parts aluminum to 1 part silicon, and may have a mix of amorphous aluminosilicate and structured zeolyte having a distribution of zeolytic cells ranging in size from about 3 Angstroms to about 16 Angstroms. Ferric oxide as used herein refers to iron (III) oxide (Fe₂O₃). Compositions comprising ferrous ferric oxide (Fe₃O₄), or mixtures of ferric oxide and ferrous ferric oxide, and the above-described zeolyte group may be used in other embodiments.

In some embodiments, the zeolyte group may comprise, include, contain, consist essentially of, or consist of clinoptilolite. Thus, the hydrogen sulfide may be removed from process streams by contacting the gas, liquid, or gas/liquid mixture containing hydrogen sulfide with a composition comprising ferric oxide and clinoptilolite according to embodiments disclosed herein. Ferric oxide as used herein refers to iron (III) oxide (Fe₂O₃). Compositions comprising ferrous ferric oxide (Fe₃O₄), or mixtures of ferric oxide and ferrous ferric oxide, and clinoptilolite may be used in other embodiments.

Contact of a gas, liquid, or gas/liquid mixture having a first concentration of hydrogen sulfide with a composition comprising ferric oxide and a zeolyte group, such as clinoptilolite, according to embodiments disclosed herein may produce an effluent having a second concentration of hydrogen sulfide less than the first concentration of hydrogen sulfide. Contact of a process stream with a composition comprising ferric oxide and a zeolyte group, such as clinoptilolite, according to embodiments disclosed herein may reduce the concentration of hydrogen sulfide in the process stream by at least 90 weight percent in some embodiments; by at least 95 weight percent in other embodiments; by at least 98 weight percent in other embodiments; by at least 99 weight percent in other embodiments; by at least 99.5 weight percent in other embodiments; and by at least 99.9 weight percent in yet other embodiments.

For example, a process stream having a concentration of hydrogen sulfide in the range from about 5 ppm to about 500 ppm may be contacted with a composition comprising ferric oxide and a zeolyte group, such as clinoptilolite, according to embodiments disclosed herein, resulting in an effluent having a concentration of hydrogen sulfide in the range from about 0 ppm to about 10 ppm, where the effluent concentration is less than the inlet concentration. In some embodiments, hydrogen sulfide may be removed to a concentration below detectable limits.

Compositions comprising ferric oxide and clinoptilolite according to embodiments disclosed herein may be contacted with the process streams as a fixed bed (or static bed), a fluidized bed, a moving bed, or other manners of contacting gases and liquids with a solid. In some embodiments, compositions comprising ferric oxide and a zeolyte group such as clinoptilolite may be disposed as a fixed bed layer or layers in a vessel. In other embodiments, compositions comprising ferric oxide and a zeolyte group such as clinoptilolite may be disposed as a fixed bed layer or layers in a vessel, where the vessel contains one or more additional layers containing structures or compositions for removing other impurities from the process stream, such as metals, water or hydroxide-containing compounds, nitrogen-containing compounds, and chlorine-containing compounds.

Compositions comprising ferric oxide and a zeolyte group such as clinoptilolite may be provided in any number of shapes and sizes as suitable for the type of service (fixed bed, fluidized bed, etc.). For example, the ferric oxide and clinoptilolite may be co-mingled, such as on a microscopic scale, at a ratio of ferric oxide to clinoptilolite in the range from about 0.1 to about 10 parts of ferric oxide per part of clinoptilolite. The resulting mixture may then be formed (e.g., tabletted or extruded in the presence or absence of a binder) into a particle. The mixing may be achieved using a blender, such as a ribbon blender or other powder mixing devices. In some embodiments, the blended materials are mixed with water, acid or base, and a binder, such as silica, clay, titania, zirconia, alumina and the like to form an extrudable mixture. This mixture can be extruded and/or formed into any suitable shape including cylinders, cubes, stars, tri-lobes, quadra-lobes, pellets, pills, spheres, or shapes containing hollow cores of varying diameters by suitable mechanical means. For example, the ferric oxide, clinoptilolite and other components may be blended using a ribbon blender and extruded using a KAHL pelletizer to produce pellets having a desired size. In other embodiments, blends of ferric oxide and clinoptilolite may be spray dried, or the structures containing an intimate blend of ferric oxide and clinoptilolite may be ground or otherwise comminuted, to form dusts, particles, powders, granules or other similar structures comprising ferric oxide and clinoptilolite. In some embodiments, the compositions comprising clinoptilolite and ferric oxide may be in the form of cylinders having a diameter in the range from about 2 mm to about 8 mm.

The structures and compositions comprising ferric oxide and clinoptilolite according to embodiments disclosed herein may contain a binder, such as alumina, silica, and other binders known to those of skill in the art. In other embodiments, structures and compositions comprising ferric oxide and clinoptilolite according to embodiments disclosed herein may contain at least one of sodium oxide zeolite, magnesium aluminosilicate, potassium aluminosilicate, calcium aluminosilicate, opaline silica, and Portland cement. Such structures may have a surface area of at least 3 m²/g, such as in the range from about 100 m²/g to about 400 m²/g in some embodiments. The structures and compositions comprising ferric oxide and clinoptilolite according to embodiments disclosed herein may have a pore volume in the range from about 0.2 cc/g to about 0.65 cc/g.

Compositions comprising ferric oxide and a zeolyte group such as clinoptilolite according to embodiments disclosed herein preferentially do not contain zinc and copper. However, these metals may be present as impurities in the ferric oxide or other raw materials used during preparation of the compositions. Thus, compositions comprising ferric oxide and a zeolyte group such as clinoptilolite according to embodiments disclosed herein may contain from 0 wt. % to less than 1 wt. % copper and from 0 wt. % to less than 1 wt. % zinc.

In some embodiments, compositions comprising ferric oxide and clinoptilolite according to embodiments disclosed herein may contain: 0.1 to 90 weight percent sodium oxide zeolite; 0.1 to 90 weight percent magnesium aluminosilicate; 0.1 to 90 weight percent potassium aluminosilicate; 0.1 to 90 weight percent calcium aluminosilicate; 5 to 50 weight percent Portland cement; 1 to 30 weight percent opaline silica; 1 to 90 weight percent clinoptilolite; 1 to 90 weight percent ferric oxide; 0 to less than 1 weight percent zinc; and 0 to less than 1 weight percent copper.

In other embodiments, compositions comprising ferric oxide and clinoptilolite according to embodiments disclosed herein may contain: 5 to 90 weight percent sodium oxide zeolite; 5 to 90 weight percent magnesium aluminosilicate; 5 to 90 weight percent potassium aluminosilicate; 5 to 90 weight percent calcium aluminosilicate; 10 to 30 weight percent Portland cement; 5 to 20 weight percent opaline silica; 5 to 80 weight percent clinoptilolite; 5 to 90 weight percent ferric oxide; 0 to less than 1 weight percent zinc; and 0 to less than 1 weight percent copper.

In addition to adsorption of hydrogen sulfide, compositions according to embodiments disclosed herein may also be useful for the adsorptive removal of various other sulfur containing species, including carbonyl sulfide, carbon disulfide, and mercaptans, among others.

Contact of the hydrogen sulfide-containing process streams with compositions comprising ferric oxide and a zeolyte group such as clinoptilolite according to embodiments disclosed herein may be performed at temperatures, pressures, and flow rates commonly used for the associated upstream and downstream processing steps. For example, an effluent from a reformer may be fed to a fixed bed for removal of hydrogen sulfide and/or other contaminants, where the effluent may be fed directly to the fixed bed without any intermediate processes to increase or decrease the temperature or pressure of the effluent. In other embodiments, the temperature and/or pressure of the streams may be adjusted prior to contact, such as the compression of a hydrogen or natural gas stream. In some embodiments, contact may be performed at temperatures in the range from ambient or about 10° C. to about 300° C., pressures in the range from about 0.1 bar to about 50 bar, such as in the range from about 3 bar to about 30 bar, and space velocities in the range from about 1 h⁻¹ to about 200 h⁻¹, such as in the range from about 80 h⁻¹ to about 150 h⁻¹.

Contact of the hydrogen sulfide-containing process streams with compositions comprising ferric oxide and a zeolyte group such as clinoptilolite according to embodiments disclosed herein may react hydrogen sulfide with the ferric oxide to form non-stoichiometric iron sulfide (FeₓSₓ, such as Fe₂S₃ or Fe₃S₄, for example). In some embodiments, the resulting composition including non-stoichiometric iron sulfide is not pyrophoric.

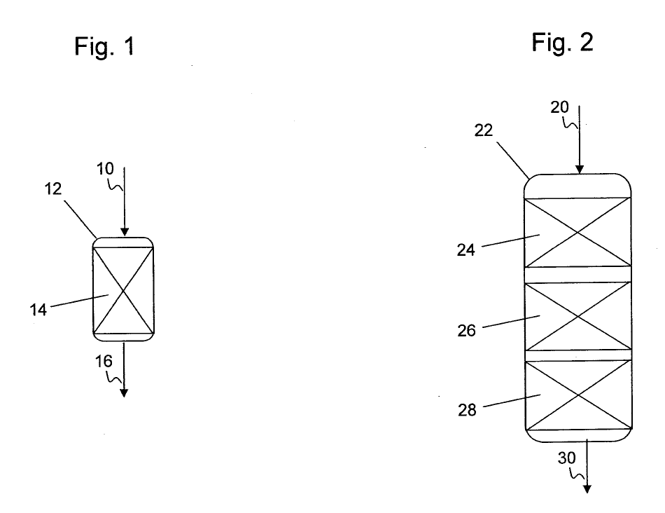

Referring now to FIG. 1, a process for removing hydrogen sulfide from a process stream according to embodiments disclosed herein is illustrated. A stream 10 containing hydrogen sulfide, such as a hydrogen recycle stream from a hydrogen sulfide stripper or a natural gas process stream, is fed to a vessel 12 for removing at least a portion of the hydrogen sulfide from the stream. Vessel 12 may contain one or more beds 14 containing compositions comprising ferric oxide and clinoptilolite according to embodiments disclosed herein. The hydrogen sulfide in the feed stream reacts with the composition, forming non-stoichiometric ferric sulfide. An effluent 16 is recovered from vessel 12 having a reduced concentration of hydrogen sulfide as compared to stream 10.

Referring now to FIG. 2, a process for removing hydrogen sulfide and other impurities from a process stream according to embodiments disclosed herein is illustrated. A stream 20 containing multiple impurities, such as a reformer outlet stream containing hydrogen chloride, organic chlorides, olefins, and hydrogen sulfide, is fed to a vessel 22 for removing at least a portion of the hydrogen chloride and hydrogen sulfide. Vessel 22 may contain one or more beds 24 containing compositions for adsorbing at least a portion of the hydrogen chloride and one or more beds 26 containing compositions comprising ferric oxide and clinoptilolite according to embodiments disclosed herein for adsorbing at least a portion of the hydrogen sulfide. One or more beds 28 may also be provided to remove additional impurities, where the placement of bed 28 may be above, intermediate, or below beds 24, 26. An effluent 30 is then recovered from vessel 22 having a reduced concentration of both hydrogen sulfide and hydrogen chloride as compared to stream 20.

As described above, embodiments disclosed herein provide processes and compositions useful for the reduction or removal of hydrogen sulfide from various process streams. Specifically, compositions useful for the reduction or removal of hydrogen sulfide include ferric oxide and a zeolyte group such as clinoptilolite. Ferric oxide and clinoptilolite may be obtained from any of a number of sources. In some embodiments, the ferric oxide may be recovered from the pickling liquor of a steel mill, such as by roasting the pickling liquor containing ferric chloride to produce ferric oxide powder (e.g., a beta phase ferric oxide sourced from ferric chloride roasted at a high temperature). The clinoptilolite, a natural ore, may be obtained from various sources worldwide, and in some embodiments may be obtained from the Bear River Zeolite Company, Preston, Id.

Advantageously, embodiments disclosed herein may provide for the efficient reduction or removal of hydrogen sulfide from process streams using compositions including ferric oxide and a zeolyte group such as clinoptilolite. Such compositions may be formed using inexpensive raw materials, providing a cost savings over various prior art materials used for a similar service. Additionally, following reaction of hydrogen sulfide with compositions including ferric oxide and clinoptilolite according to embodiments disclosed herein may produce a non-stoichiometric iron sulfide that is not pyrophoric, thus reducing the costs for removal of spent adsorbents from a vessel as well as costs associated with disposal or recycling of the spent material.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

1. A composition useful for the adsorptive removal of hydrogen sulfide from a gas or liquid stream, the composition comprising ferric oxide and a zeolyte group, the zeolyte group:
comprising aluminum and silicon at a ratio in the range from about 1 part aluminum to 100 parts silicon to about 100 parts aluminum to 1 part silicon; and having a mix of amorphous aluminosilicate and structured zeolyte;
wherein the structured zeolyte comprises a distribution of zeolytic cells ranging in size from about 3 Angstroms to about 16 Angstroms.

2. The composition of claim 1, wherein the zeolyte group comprises clinoptilolite.

3. The composition as claimed in claim 1, further comprising a binder.

4. The composition of claim 1, further comprising at least one of sodium oxide zeolite, magnesium aluminosilicate, potassium aluminosilicate, calcium aluminosilicate, opaline silica, and Portland cement.

5. The composition of claim 1, wherein the composition has a surface area of at least 10 m/g.

6. The composition of claim 1, wherein the composition has a surface area in the range from about 100 m 2/g to about 400 m 2/g.

7. The composition of claim 1, wherein the composition has a pore volume in the range from about 0.2 cc/g to about 0.65 cc/g.

8. The composition of claim 1, wherein the composition is shaped in the form of a cylinder, cube, star, tri-lobe, quadra-lobe, pellet, pill, tablet, sphere, a shape containing a hollow core, or combinations thereof.

9. The composition of claim 1, wherein the composition comprises from 0 wt. % to less than 1 wt. % copper and from 0 wt. % to less than 1 wt. % zinc.

10. The composition of claim 1, wherein the composition comprises from about 0.1 to about 10 parts of ferric oxide per part of clinoptilolite.

11. The composition of claim 1, wherein the composition comprises:
0.1 to 90 weight percent sodium oxide zeolite;
0.1 to 90 weight percent magnesium aluminosilicate;
0.1 to 90 weight percent potassium aluminosilicate;
0.1 to 90 weight percent calcium aluminosilicate;
5 to 50 weight percent Portland cement;
1 to 30 weight percent opaline silica;
1 to 90 weight percent clinoptilolite;
1 to 90 weight percent ferric oxide;
0 to less than 1 weight percent zinc; and
0 to less than 1 weight percent copper.

12. A process for the adsorptive removal of hydrogen sulfide from a gas or liquid stream, the process comprising:
contacting a gas, liquid, or gas/liquid mixture having a first concentration of hydrogen sulfide with a composition comprising ferric oxide and a zeolyte group, the zeolyte group:
comprising aluminum and silicon at a ratio in the range from about 1 part aluminum to 100 parts silicon to about 100 parts aluminum to 1 part silicon; and
having a mix of amorphous aluminosilicate and structured zeolyte; wherein the structured zeolyte comprises a distribution of zeolytic cells ranging in size from about 3 Angstroms to about 16 Angstroms;
to produce an effluent having a second concentration of hydrogen sulfide less than the first concentration of hydrogen sulfide.

13. The process as claimed in claim 12, wherein the zeolyte group comprises clinoptilolite.

14. The process as claimed in claim 12:
wherein the first concentration is in the range from about 5 ppm to about 500 ppm hydrogen sulfide; and
wherein the second concentration is in the range from about 0 ppm to about 10 ppm hydrogen sulfide.

15. The process of claim 12, wherein the gas, liquid, or gas/liquid mixture having a first concentration of hydrogen sulfide comprises at least one of:
a natural gas process or production stream;
a refinery petroleum fraction;
a hydrogen gas effluent from a hydrogen sulfide stripper or an amine absorber; and
a carbon dioxide gas stream.

16. The process of claim 12, wherein the composition further comprising a binder.

17. The process of claim 12, wherein the composition further comprises at least one of sodium oxide zeolite, magnesium aluminosilicate, potassium aluminosilicate, calcium aluminosilicate, and opaline silica.

18. The process of claim 12, wherein the composition has a surface area of at least 10 m/g.

19. The process of claim 12, wherein the composition has a surface area in the range from about 100 m 2/g to about 400 m 2/g.

20. The process of claim 12, wherein the composition has a pore volume in the range from about 0.2 cc/g to about 0.65 cc/g.

21. The process of claim 12, wherein the composition is shaped in the form of a cylinder, cube, star, tri-lobe, quadra-lobe, pellet, pill, tablet, sphere, a shape containing a hollow core, or combinations thereof.

22. The process of claim 12, wherein the composition comprises from 0 wt. % to less than 1 wt. % copper and from 0 wt. % to less than 1 wt. % zinc.

23. The process of claim 12, wherein the composition comprises from about 0.1 to about 10 parts of ferric oxide per part of clinoptilolite.

24. The process of claim 12, wherein the composition comprises:
0.1 to 90 weight percent sodium oxide zeolite;
0.1 to 90 weight percent magnesium aluminosilicate;
0.1 to 90 weight percent potassium aluminosilicate;
0.1 to 90 weight percent calcium aluminosilicate;
5 to 50 weight percent Portland cement;
1 to 30 weight percent opaline silica;
1 to 90 weight percent clinoptilolite;
1 to 90 weight percent ferric oxide;
0 to less than 1 weight percent zinc; and
0 to less than 1 weight percent copper.
